(19) United States
(12) Patent Application Publication
(10) Pub. No.: US 2016/0270385 A1
(43) Pub. Date: Sep. 22, 2016

(54) Fishing Line Clip

(71) Applicant: Daniel S Stearman, Alameda, CA (US)

(72) Inventor: Daniel S. Stearman, Alameda, CA (US)

(21) Appl. No.: 15/035,116

(22) PCT Filed: Nov. 6, 2014
(86) PCT No.: PCT/US14/64435

§ 371 Date: May 6, 2016

Related U.S. Application Data
(60) Provisional application No. 61/900,913, filed on Nov. 6, 2013.

(51) Int. Cl. A01K 97/06; B21D 53/36; A01K 91/06

(52) U.S. Cl. CPC A01K 97/06; A01K 91/06; B21D 53/36

(57) ABSTRACT

A clip includes an exterior perimeter and two opposing flaps. The two opposing flaps may share a common end, with one flap extending out of the plane of the exterior perimeter. Rotation of the flap extending out of the plane towards the plane of the exterior perimeter rotates the opposing flap to open the clip. The clip may include a hook or other attachment feature such that the clipped object may be secured to a second object. In an exemplary application, the clip is used with a fishing line and pole to secure the line between the clip and hook the line to a pole for storage or transport.

### PRIORITY

This application claims the benefit of priority to U.S. Provisional Application No. 61/990,913, filed Nov. 6, 2013, and titled “Fishing Line Clip,” which is incorporated herein by reference in its entirety into this application.

### BACKGROUND

Fishing is a pastime enjoyed by many people. Generally, a rod is used to support a line that has bait or other ornamental enticement to attract a fish. Along with the bait or lure, a hook is provided at the end of the line to hook the fish once it attempts to bite the bait or lure. The rod may include one or more mechanisms to retract the line once a fish is hooked. The lure and/or hook may be changed in between fishing events and/or in between individual casts depending on the fish, season, interest of the fisherman, etc. When the lure and/or hook is removed there is not an easy way to releasably hold the line in a stored configuration as another lure and/or hook is retrieved. Typical hooks or attachment mechanisms kink or bend the fishing line. This can cause problems in weakening the line or in casting the lure. Other attachment mechanisms may otherwise adversely affect the line and/or be difficult to release.

### DRAWINGS

FIG. 1 is a front perspective view of an exemplary embodiment of a fishing line clip;

FIG. 2 is a rear perspective view of the fishing line clip illustrated in FIG. 1;

FIG. 3 is a front elevation view of the fishing line clip illustrated in FIG. 1;

FIG. 4 is a rear elevation view of the fishing line clip illustrated in FIG. 1;

FIG. 5 is a first side elevation view of the fishing line clip illustrated in FIG. 1;

FIG. 6 is a second side elevation view of the fishing line clip illustrated in FIG. 1;

FIG. 7 is a top view of the fishing line clip illustrated in FIG. 1;

FIG. 8 is a bottom view of the fishing line clip illustrated in FIG. 1;

FIGS. 9A and 9B are side views of the fishing line clip illustrated in FIG. 1 translating between the closed configuration, FIG. 9A, and an open configuration, FIG. 9B;

FIG. 10 is an engineering drawing of an exemplary fishing line clip, drawn to scale; and

FIG. 11A is a front view, and FIG. 11B is a back view of an exemplary clip and hook in a finished configuration including coating and optional promotional and/or branding information.

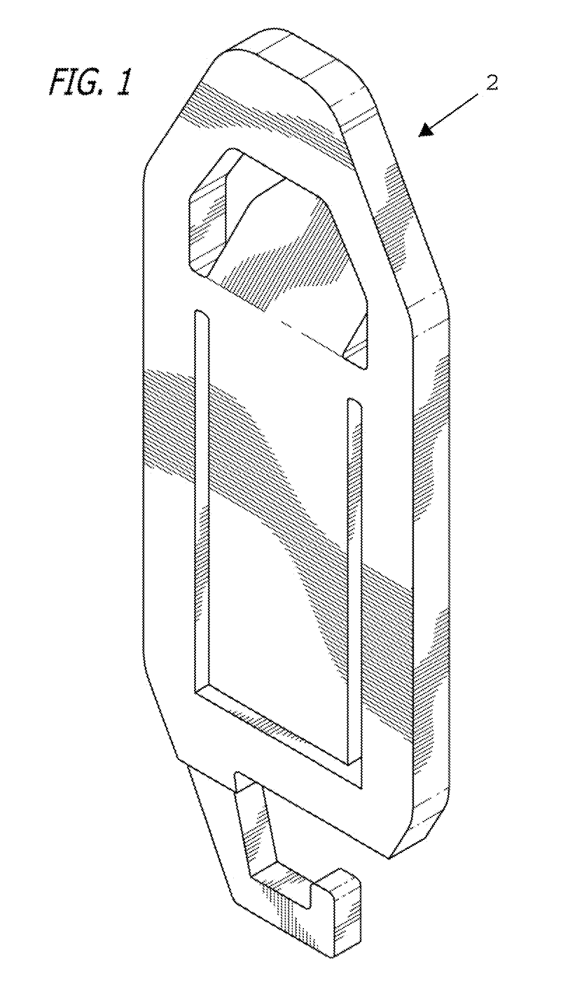

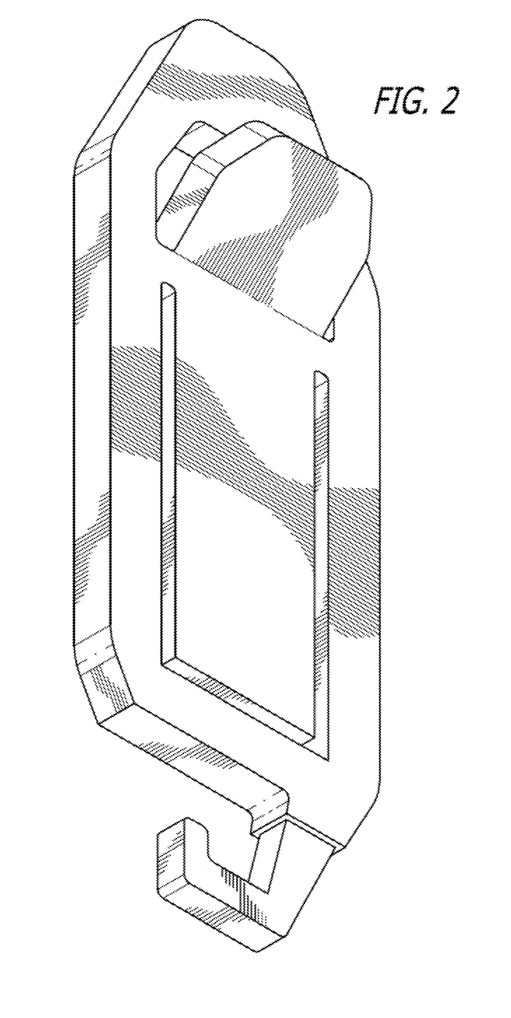

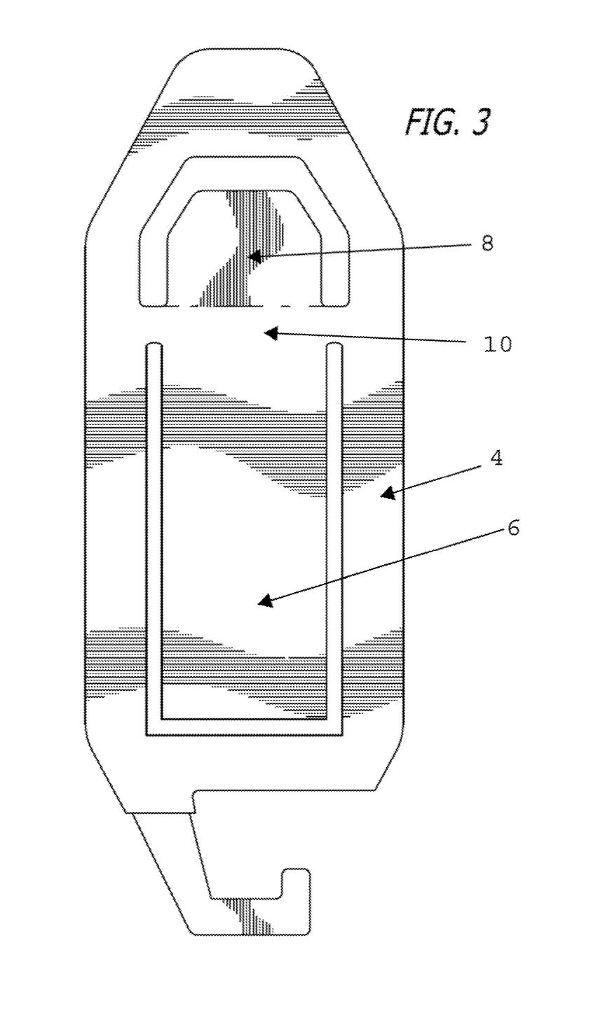

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

An exemplary fishing line clip is shown and described herein. The clip may include one or more mechanisms to retain a fishing line between separable portions without kinking or permanently bending the line. The clip should permit easy connection and disengagement of the fishing line therefrom. The clip should also sufficiently grip the line to firmly retain the line within the clip for a short or extended duration such as during storage, transport, etc. of the fishing pole.

Although embodiments of the invention may be described and illustrated herein in terms of fishing applications, it should be understood that embodiments of this invention are not so limited, but are additionally applicable to any use of a clip.

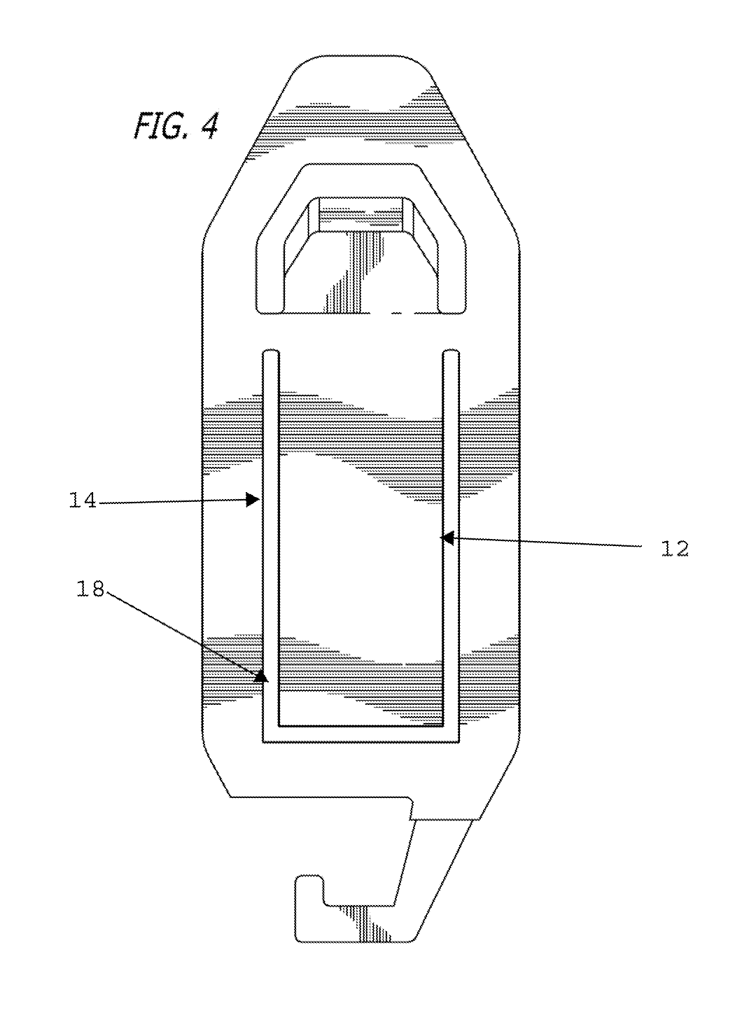

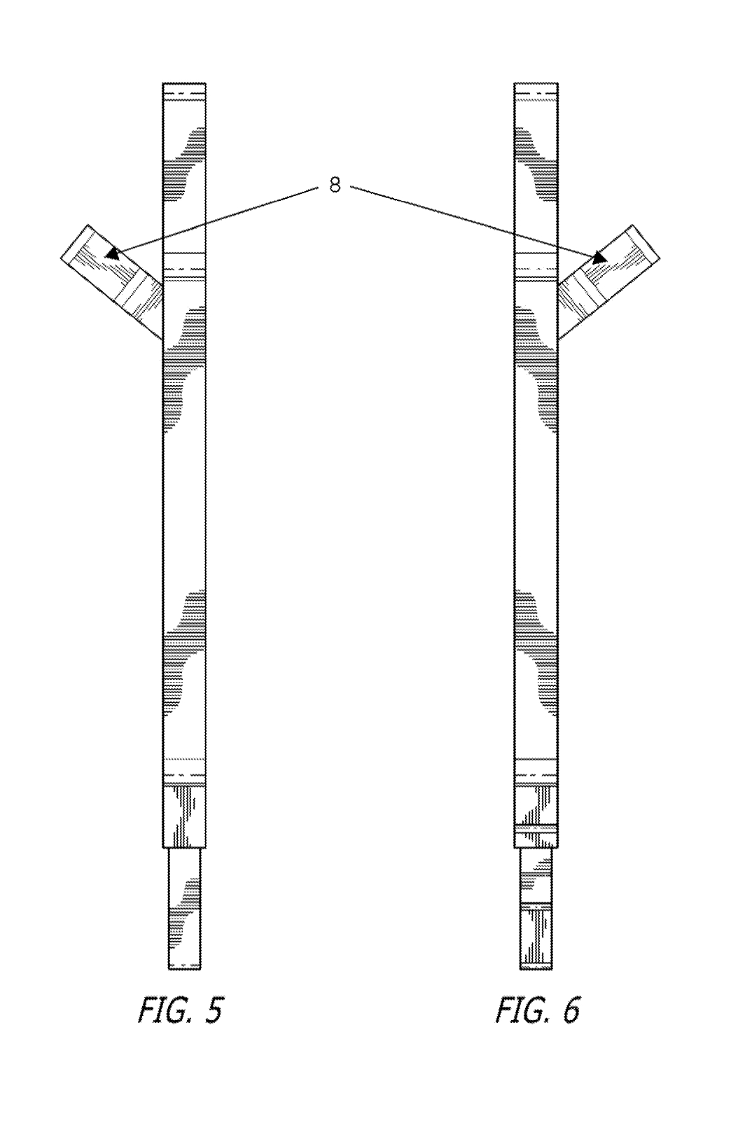

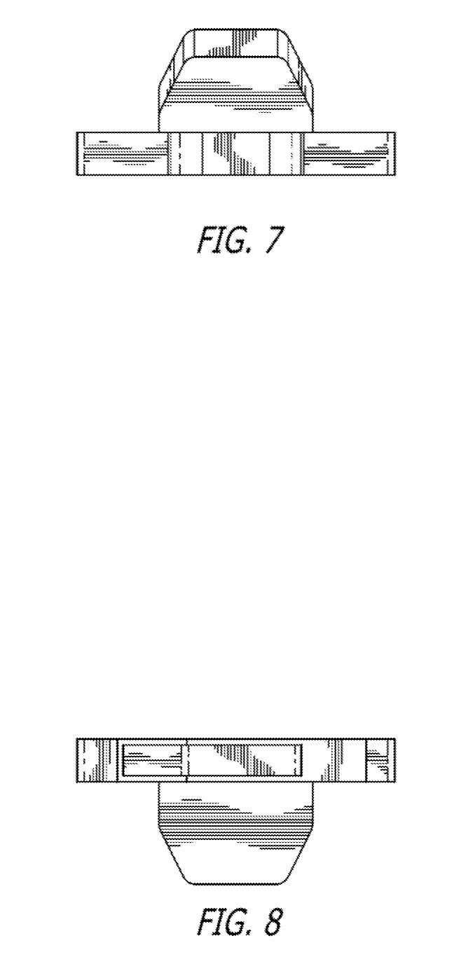

In an exemplary embodiment a fishing line clip 2 is provided with an exterior perimeter 4 and two opposing interior flap sections 6, 8. The exterior perimeter 4 is connected to the two opposing interior flap sections 6, 8 by a bridge 10 defining a common base of the opposing interior flap sections. The interior flap sections are otherwise separate from and moveable with respect to the exterior perimeter section. The bridge 10 connection acts as a hinge joint about which the respective flap sections 6, 8 rotate. In a closed configuration, as seen in FIGS. 5-6, a first flap 8 extends out of the plane of the clip with the second flap 6 generally contained within or parallel to the plane of the exterior perimeter.

One or more exterior edges 12 of the second flap 6 used to retain the fishing line and/or one or more interior edges 14 of the exterior perimeter 4 facing the second flap 6 may be curved or contoured to further retain the fishing line without kinking, bending, or permanently adversely affecting the line. For example, opposing edges or all edges of the flap and corresponding adjacent edges of the exterior perimeter may be rounded, curved, or smoothed to provide a sinusoidal transitional surface for the line about the edges of the clip. One or more exterior surfaces of any and/or all of the punched surfaces of the clip may also be rounded or smoothed to prevent the clip from scratching or scraping the line and/or portion of the pole, and/or to provide a more pleasant gripping interface.

The clip 2 may be shaped to be ergonomic. Therefore, the first flap 8 may include a depression or contour shaped to conform to a thumb while the exterior perimeter may be rounded or shaped to support or abut a finger or other portion of the hand. For example, the first flap may include a generally concave indention along a portion of the flap and the exterior perimeter may be tapered along an end of the clip adjacent the end of the first flap away from the bridge.

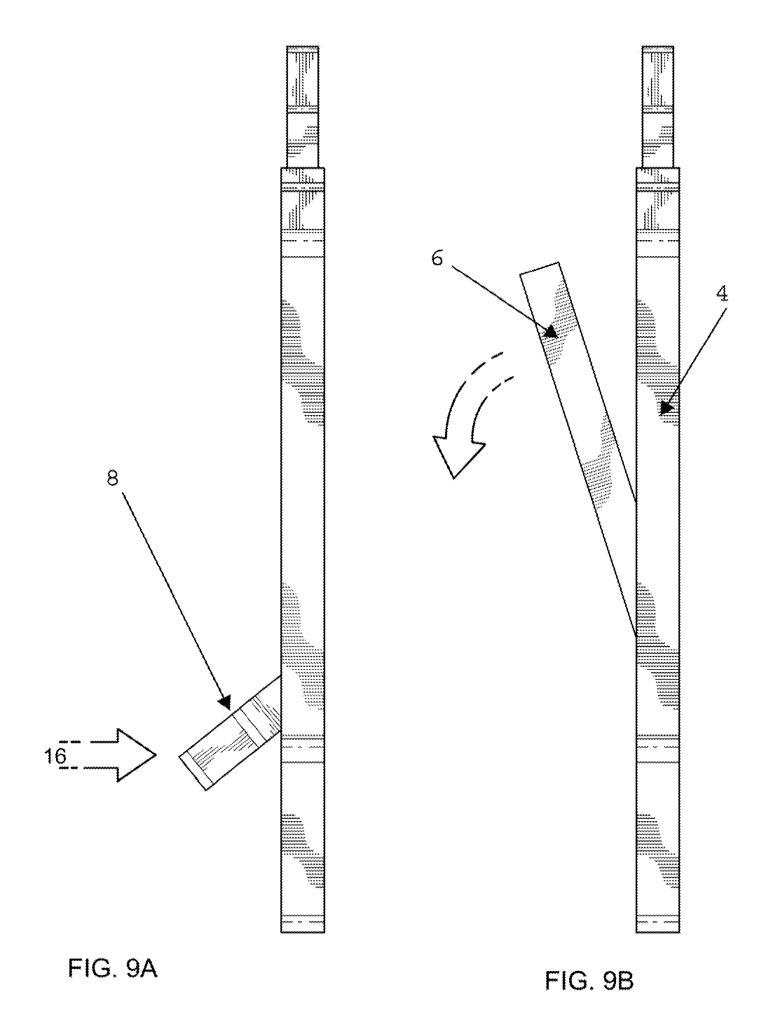

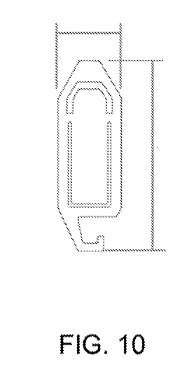

As seen in FIG. 9A, the clip 2 may be biased in the closed configuration, such that an external force 16 is applied to the first flap 8 to rotate both the first flap 8 and the second flap 6 about the bridge to open the opposing flap 6 and permit the line to be inserted between the opposing flap 6 and the exterior perimeter 4. When the external force is removed, the first flap 8 and opposing flap 6 rotate in the opposite direction to bring the opposing flap 6 back toward alignment with the exterior perimeter 4. The separation distance or gap 18 between the opposing flap 6 and exterior perimeter 4 is sufficiently sized to grip the fishing line but large enough that the line is not kinked, bent, cut, or otherwise compromised when positioned in between.

Alternatively, the clip may be passive such that the respective flaps rotate upon application of an external force. When the force is removed, the flaps maintain the same configuration whether open or closed. Therefore, for example, the clip may be in a closed configuration, when pressure is applied to the first flap, the first and second flaps rotate about the bridge as the first flap approaches the plane of the clip and the second flap separates or is angled with respect to the plane of the clip. When the force is removed, the clip stays in the open configuration. To close the clip, pressure is applied on the second flap to rotate it back toward the plane of the clip. The flap will stay in the desired position, thus applying a set force and retention force on the line as desired by the user.

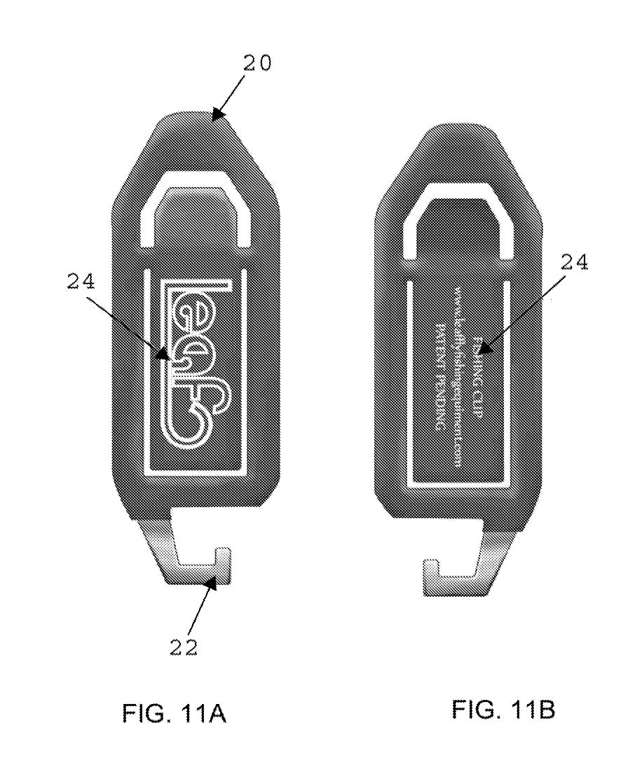

As illustrated in FIGS. 11A and 11B, the clip 2 may include an exterior coating 20 along all or a portion of the clip, such as over and/or around the opposing flap 6 and or corresponding portion of the exterior perimeter 4 to provide an increased gripping surface for the line and/or a compliant surface to reduce the potential to kink the line. As shown, a rubberized coating 20 is provided over a substantial portion of the clip including the exterior perimeter 4 and the first and opposing flaps, 8 and 6, and the bridge 10. The coating may fill a majority (e.g. 50% or more), substantially (e.g. 75% or more) or completely (e.g. 95% or more) a gap between the exterior perimeter and the second flap 6, such that when a line is positioned between the flap and the exterior perimeter, the coating provides a frictional engagement to retain the line in place relative to the clip.

The clip may also include a hook 22 at one end to retain the clip and attached line to a portion of the fishing pole. Other attachment mechanisms may be used in place or in conjunction with the disclosed hook. For example, a hole, hinged hook, clip, lock, flap, ridge, etc., may also be used. The hook may or may not be coated by the exterior coating.

An end of the clip opposite the hook may be shaped to reduce the profile of the clip. Alternatively, the perimeter or end of the clip may include additional features or surfaces configured to assist in other functions consistent with fishing and/or attaching lure, bait, etc. to the fishing line. For example, the clip may include a detent or indent on an interior or exterior surface away from the clip attachment section (i.e. the opposing flap 6 and immediately adjacent and surrounding exterior perimeter, 14, 4). The indent may be sharpened to cut the line when inserted into that section of the clip.

Exemplary embodiments of the clip may be made in a variety of ways. In an exemplary method of making the clip, a stainless steel generally planar sheet can be stamped with the shape of the clip including the exterior perimeter, and first and second flaps, and hook. The first flap may then be folded or bent out of the plane of the clip, for example at an angle of 45 degrees upward. To reduce the profile of the clip, the angle is preferably at or less than 45 degrees from the original orientation. However, angles of up to 90 degrees are acceptable. The transition of the first flap out of plane of the clip may be generally smooth or may be more linear and/or discontinuous. The clip may then be dipped, sprayed, powder coated, or injection molded to provide an exterior surface. Finally, the exterior surface may be painted and or screen printed with marketing information, logos, or other indicia or decoration 24. The clip may be cast molded or CNC milled or may be formed by other known methods. The clip may be made of other materials as well including plastics, metals, composites, resins, etc.

It is understood that the embodiments described herein are exemplary only. Features may be added, removed, duplicated, combined, or recombined in various configurations. For example, the first flap may be removed such that the clip is translated by pushing or pulling directly on the opposing flap used to retain the fishing line.

It is understood that the embodiments described herein are disclosed in terms of a specific application of fishing. However, the clip as described including one or more of its features may be used in a variety of applications and is not limited to those disclosed herein.

The clip is preferably ¼ to 1 inch wide, and more preferably ½ to ¾ of an inch and 0.6 inches as shown. The clip is preferably 1-2 inches long, 1.5-2 inches long, and approximately 1.75-1.8 inches as shown. The clip is preferably between 0.01 and 0.05 inches thick, and more preferably between 0.015-0.02 inches. The clip is preferably stainless steel, but can be any other easily machined, or stamped material, that permits the rotation of the flaps and described above and maintains the desired retention force on the line. The clip may be made of other materials as well, such as plastic.

Exemplary embodiments described herein may be used to secure a line to a rod when a hook is not already on the line. The clip may be opened, the line inserted, and the clip closed to secure the line within the clip. The hook or other attachment feature of the clip may be used to secure the line to the fishing rod, such as at one of the line loops on the pole. The line can then be tightened such that the slack is taken from the line and the hook secured between the pole and the line. The frictional engagement between the clip and the line secures the line to the clip and through the clip to the pole. The clip may also be attached directly to the line when the reel is separate from the pole, such that the end of the line is secure on the reel. The clip can be attached to any surface for use and/or storage.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

I claim:

1. A fishing line clip comprising: a body section with an exterior perimeter and interior flap, wherein the interior flap is configured to rotate out of a plane of the clip defined by the exterior perimeter in an open configuration and aligned with the plane in the closed configuration.

2. The fishing line clip of claim 1, further comprising a second flap.

3. The fishing line clip of claim 2, wherein the second flap projects out of the plane of the clip in the closed configuration.

4. The fishing line clip of claim 3, wherein the interior flap and second flap share a common end defining a bridge connecting the interior and second flaps to the exterior perimeter.

5. The fishing line clip of claim 4, wherein the interior flap and second flap extend in opposing directions from the common end.

6. The fishing line clip of claim 5, wherein the interior flap and second flap are separated from the exterior perimeter at opposing ends away from the common end.

7. The fishing line clip of claim 6, further comprising a hook at one end of the exterior perimeter.

8. The fishing line clip of claim 7, wherein the exterior perimeter fully circumscribes the interior flap and second flap.

9. The fishing line clip of claim 7, further comprising an exterior surface layer along a majority portion of the clip.

10. The fishing line clip of claim 9, wherein the exterior surface layer is along at least the interior flap, second flap and at least a portion of the exterior perimeter proximate the interior flap.

11. The fishing line clip of claim 10, wherein the exterior surface layer fills a separation gap between the exterior perimeter and the interior flap when the interior flap is in a closed configuration.

12. The fishing line clip of claim 8, wherein a separation distance between the second flap and the exterior perimeter immediately adjacent thereto is greater than the separation distance between the interior flap and the exterior perimeter immediately adjacent thereto.

13. The fishing line clip of claim 12, wherein the clip is translated between the closed to open position by applying pressure on the second flap and between the open to closed position by applying pressure on the interior flap.

14. The fishing line clip of claim 12, wherein the second flap is curved out of the plane of the exterior perimeter.

15. The fishing line clip of claim 14, wherein the interior flap is configured to rotate out of a plane of the clip defined by the exterior perimeter when a force is applied to the second flap to rotate the second flap toward the plane of the clip.

16. The fishing line clip of claim 15, comprising stainless steel.

17. A method of manufacturing a fishing line clip of claim 2, wherein the clip is stamped from a sheet of stainless steel.

18. The method of manufacturing of claim 17, wherein the second flap is bent out of the plane of the clip to approximately 45 degrees or less.

19. The method of manufacturing of claim 18, wherein the stamped and bent clip is dip coated in rubber.

20. The method of manufacturing of claim 18, wherein stamped edges are smoothed.
